(19) United States
(12) Patent Application Publication
(10) Pub. No.: US 2008/0058158 A1
(43) Pub. Date: Mar. 6, 2008

(54) CONTROL DEVICE AND CONTROL METHOD FOR VEHICLE

(75) Inventors: Nobufusa KOBAYASHI, Anjyo-shi (JP); Toshio Sugimura, Ann Arbor, MI (US); Tomohiro Asami, Nissin-shi (JP); Takaaki Tokura, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/850,936

(22) Filed: Sep. 6, 2007

(30) Foreign Application Priority Data
Sep. 6, 2006 (JP) 2006-241387

(51) Int. Cl. F16H 61/12

(52) U.S. Cl. 477/134; 701/53

(57) ABSTRACT

An ECU for a vehicle equipped with an automatic transmission includes a detection unit that detects a position of a transmission selection member manipulated by a driver; a determination unit that determines whether a gear step is abnormal when a preset time has elapsed after the transmission selection member is shifted from a drive position to a neutral position. The ECU further includes a control unit that controls the automatic transmission such that if the transmission selection member is shifted from the neutral position to the drive position when the gear step has been determined to be abnormal, a shock generated by the engagement of the frictional engagement elements is reduced.

### INCORPORATION BY REFERENCE

The disclosure of Japanese Patent Application No. 2006-241387 filed on Sep. 6, 2006 including the specification, drawings and abstract is incorporated herein by reference in its entirety.

### BACKGROUND OF THE INVENTION

1. Field of the Invention

The present invention relates to a control device and a control method for a vehicle; and, more particularly, to a control device and a control method for a vehicle equipped with an automatic transmission that forms gear steps by engaging frictional engagement elements.

2. Description of the Related Art

In a conventional automatic transmission, gear steps are formed by engaging frictional engagement elements through the use of a hydraulic pressure supplied to the frictional engaging engagement elements. The automatic transmission forms a gear step according to a position of a shift lever. When the shift lever is in a drive (D) position, the hydraulic pressure is supplied to the frictional engagement elements of the automatic transmission, thus automatically forming a first or a higher forward drive gear step. When the shift lever is in a neutral position, the hydraulic pressure is released from the frictional engagement elements via a manual valve interlocked with the shift lever. Accordingly, the automatic transmission is placed in a neutral state.

However, if a neutral start switch (also referred to as “position switch”) that detects the position of the shift lever malfunctions, the neutral position may be detected despite the fact that the shift lever is actually in the drive position. Therefore, if the automatic transmission is controlled to suppress the generation of the hydraulic pressure, when the shift lever is detected to be in a neutral position, it may not be possible to establish the forward drive gear steps if the neutral start switch malfunctions. In such a case, it will not be possible to drive the vehicle even though the shift lever is actually in the drive position. To that end, there has been proposed a technique that controls the hydraulic pressure even when the shift lever is detected to be in the neutral position, in the case where the shift lever is detected to be in the drive position.

Japanese Patent Application Publication No. 2005-240992 (JP-A-2005-240992) describes an automatic transmission control device that enables a vehicle to be driven even when a range position detector is out of order. The control device described in JP-A-2005-240992 includes: a range position detector that outputs signals for detecting range positions selected by a shift lever manipulated by a driver and an intermediate positions between the range positions by manipulating a shift lever, the range positions including at least a parking range (P range), a reverse range (R range), a neutral range (N range) and a drive range (D range); a plurality of hydraulic pressure control valves that control the hydraulic pressure that is supplied to the frictional engagement elements in the automatic transmission; and a manual conversion valve interlocked with the manipulation of the shift lever to allow hydraulic pressure supply circuits for the hydraulic control valves, wherein hydraulic pressure supply circuits are established for hydraulic pressure control valves of frictional elements required to set forward drive gear steps only when the shift lever is positioned at the D range. The control device further includes: a transmission control unit that controls the hydraulic pressure control valves according to the range positions detected based on the output signals from the range position detector so that the gear steps are switched by controlling the engagement of the frictional engagement elements with the hydraulic pressure supplied thereto; and a hydraulic pressure control unit where the hydraulic pressure control unit treats the detected range as the D range under a specific condition even when the range position detected by the range position detector is other than the D range, and then controls the hydraulic pressure to establish specific required forward drive gear steps.

According to the control device described in JP-A-2005-240992, even when the detected range position is other than the D range, the hydraulic pressure is controlled to establish forward drive gear steps without checking whether the detection result may be erroneous. If the detection result of other than the D range is not an error, then the shift lever is positioned at a range other than the D range, and the manual conversion valve is in a state other than the D range (i.e., the state established where the hydraulic pressure supply circuits are not established for the hydraulic pressure control valves of the frictional engagement elements required to set the forward drive gear steps). Accordingly, even if the hydraulic pressure control is executed to set the forward drive gear steps, the forward drive gear steps are not established and, thus, the vehicle cannot move forward. Meanwhile, when the shift lever is positioned to the D range, the manual conversion valve is also in the state allowing the D range. Therefore, even when the range position is misjudged as a range other than D range, the forward drive gear steps can be set by executing the hydraulic pressure control that establishes the forward drive gear steps. As a result, even when the D range cannot be detected due to erroneous output signals from the range position detector, the vehicle can be driven by shifting the shift lever to the D range.

The control device described in JP-A-2005-240992 executes the hydraulic pressure control even when the shift lever is detected to be in the neutral position, as in the case where it is detected to be in the drive position. In such a case, the frictional engagement elements may be rapidly engaged if the neutral start switch does not malfunction and the shift lever is actually shifted from the neutral position to the drive position, resulting in a great shock generated by the engagement of the frictional engagement elements.

Therefore, when the frictional engagement elements are disengaged by the shift lever actually positioned at the neutral position, i.e., when it may be detected that a rotational speed of an input shaft of the automatic transmission is not synchronous with a rotational speed of an output shaft, it is considered to execute a control that reduces the shock generated when the shift lever is shifted from the neutral position to the drive position. However, in addition to the case where the shift lever is actually at the neutral position, the rotational speeds of the input shaft and the output shaft may become asynchronous when the gear step of the automatic transmission is shifted. Therefore, if the gear shift is executed while the shift lever is rapidly malfunctioned from the drive position to the neutral position and then to the drive position again, the control that reduces the shock may be unnecessarily executed.

### SUMMARY OF THE INVENTION

The present invention provides a control device and a control method for a vehicle capable of preventing an unnecessary control.

In accordance with a first aspect of the present invention, there is provided a control device for a vehicle equipped with an automatic transmission that forms gear steps by engaging frictional engagement elements, including: a detection unit that detects a position of a transmission selection member manipulated by a driver; a determination unit that determines whether a gear step is abnormal when a preset time has elapsed since the transmission selection member had been shifted from a drive position to a neutral position; and a control unit that controls the automatic transmission such that if the transmission selection member is switched from the neutral position to the drive position in a state where the gear step has been determined to be abnormal, a shock generated by the engagement of the frictional engagement elements is reduced. The control unit may control the automatic transmission such that if the transmission selection member is switched from the neutral position to the drive position in a state where the gear step has been determined to be abnormal, the frictional engagement elements are engaged loosely in comparison to when the transmission selection member is maintained in the drive position and the frictional engagement elements are engaged normally.

The position of the transmission selection member manipulated by the driver is detected by a detection unit. In case the preset time has elapsed since the transmission selection member had been switched from the drive position to the neutral position, the gear step is determined to be abnormal. Further, in case the transmission selection member is switched from the neutral position to the drive position in a state where the gear step is determined to be abnormal, the automatic transmission is controlled so that the frictional engagement elements can be engaged loosely in comparison to when the transmission selection member is maintained in the drive position and the frictional engagement elements are engaged normally. Therefore, when the transmission selection member is slowly moved from the drive position to the neutral position and then to the drive position, the control that allows the loose engagement of the frictional engagement members is executed. On the other hand, when the manipulation is rapidly moved, the control that allows the loose engagement of the frictional engagement members may not be executed. In other words, when the frictional engagement elements are disengaged, the control that reduces a shock generated by the engagement of the frictional engagement elements is executed. However, when the frictional engagement elements are engaged, the control that reduces the shock generated by the engagement of the frictional engagement elements are not executed. As a result, it is possible to provide a control device for a vehicle capable of preventing an unnecessary control.

The frictional engagement elements may be preferably engaged by a hydraulic pressure supplied thereto. The control unit may include a unit that controls the automatic transmission such that if the transmission selection member is switched from the neutral position to the drive position in the state where the gear step is determined to be abnormal, a hydraulic pressure supplied to the frictional engagement elements is slowly increased in comparison to when the transmission selection member is maintained in the drive position and the frictional engagement elements are engaged normally. The control unit may further include a unit that controls a power source connected to the automatic transmission such that if the transmission selection member is switched from the neutral position to the drive position in the state where the gear step is determined to be abnormal an output torque from the power source is reduced to or below a predetermined value.

Accordingly, in case the transmission selection member is switched from the neutral position to the drive position in a state where the gear step is determined to be abnormal, the hydraulic pressure supplied to the frictional engagement elements is gradually increased in comparison to when the transmission selection member is maintained in the drive position and the frictional engagement elements are engaged normally. Further, the power source connected to the automatic transmission is reduced to or below the predetermined torque.

The control device further may include an error determination unit that determines whether the detection unit is functioning normally; and a unit that prohibits the determination unit from determining whether the gear step is abnormal if it is determined that the detection unit is malfunctioning.

As described above, the error determination unit determines whether the detection unit, which detects the position of the transmission selection member, is functioning normally. If it is determined that the detection unit is malfunctioning, it is not possible to accurately detect the position of the transmission selection member and, therefore, it is not possible to determine whether the gear step is normal or abnormal based on the time that has elapsed since the manipulation had been switched from the drive position to the neutral position. Accordingly, when it is determined that the detection unit is malfunctioning, the determination unit is prohibited from determining whether the gear step is abnormal. As a result, a mistaken determination can be avoided.

### BRIEF DESCRIPTION OF THE DRAWINGS

The above and other features of the present invention will become apparent from the following description of example embodiments, given in conjunction with the accompanying drawings, in which:

FIG. 1 shows a schematic diagram illustrating a power train of a vehicle;

FIG. 2 is a skeletal view of a planetary gear unit of an automatic transmission;

FIG. 3 provides an operation table of the automatic transmission;

FIG. 4 describes a hydraulic pressure circuit of the automatic transmission;

FIG. 5 offers a functional block diagram of an ECU;

FIG. 6 illustrates a speed change line diagram;

FIG. 7 presents a timing chart describing a change of a hydraulic pressure supplied to frictional engagement elements;

FIG. 8A represents a flowchart 1 showing a control sequence of a program executed by the ECU; and

FIG. 8B depicts a flowchart 2 illustrating a control sequence of a program executed by the ECU.

### DETAILED DESCRIPTION OF EMBODIMENTS

Hereinafter, example embodiments of the present invention will be described in detail with reference to the accompanying drawings. In the following description, like parts are represented by like reference numerals. The like parts have like names and like functions. Therefore, redundant description thereof will be omitted.

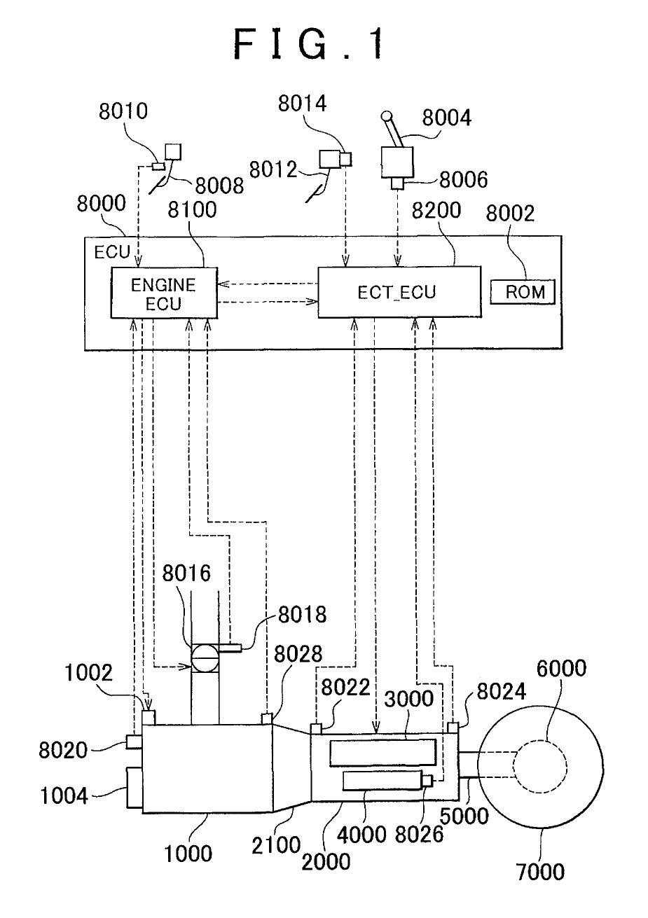

A vehicle equipped with a control device in accordance with an embodiment of the present invention will be described with reference to FIG. 1. In this embodiment, the vehicle is an FR (front engine rear drive) vehicle, but it may be a vehicle other than an FR vehicle.

The vehicle includes an engine 1000, an automatic transmission 2000, a torque converter 2100, a planetary gear unit 3000 forming a part of the automatic transmission 2000, a hydraulic circuit 4000 forming a part of the automatic transmission 2000, a propeller shaft 5000, a differential gear 6000, rear wheels 7000, and an ECU (electronic control unit) 8000. The control device of this embodiment is realized by executing a program stored in a ROM (read only memory) 8002 of the ECU 8000, for example.

The engine 1000 is an internal combustion engine in which a mixture of air and fuel injected from an injector (not shown) is combusted in a combustion chamber of a cylinder. A piston in the cylinder is pushed down by the combustion to rotate a crankshaft. Auxiliary machineries 1004 such as an alternator, an air conditioner and the like are driven by a driving force of the engine 1000. Further, instead of or in addition to the engine 1000, a motor can be employed as a power source.

The automatic transmission 2000 is connected to the engine 1000 via the torque converter 2100. The automatic transmission 2000 converts a rotational speed of the crankshaft to a desired rotational speed by establishing a desired gear step.

The power output from the automatic transmission 2000 is transferred to the left and right rear wheels 7000 on both sides via the propeller shaft 5000 and the differential gear 6000.

A neutral start switch 8006 of a shift lever 8004 (transmission selection member), an accelerator operation amount sensor 8010 of an accelerator pedal 8008, a stroke sensor 8014 of a brake pedal 8012, a throttle opening degree sensor 8018 of an electric throttle valve 8016, an engine speed sensor 8020, an input shaft speed sensor 8022, an output shaft speed sensor 8024, an oil temperature sensor 8026 and a water temperature sensor 8028 are all connected to the ECU 8000 via a harness or the like.

The neutral start switch 8006 detects the position of the shift lever 8004 and transmits a signal that indicates the detected shift lever position to the ECU 8000. A gear step of the automatic transmission 2000 is automatically set in accordance with the position of the shift lever 8004. Alternatively, a driver may arbitrarily set a gear step in a manual shift mode.

The accelerator operation amount sensor 8010 detects the operation amount of an accelerator pedal 8008 and then transmits a signal that indicates the detected operation amount to the ECU 8000. The stroke sensor 8014 detects a stroke quantity of the brake pedal 8012 (a force required for a driver to press the brake pedal 8012) and transmits a signal that indicates the detected stroke quantity to the ECU 8000.

The throttle opening degree sensor 8018 detects the opening degree of the electric throttle valve 8016, which is controlled by an actuator, and transmits a signal that indicates the detected opening degree to the ECU 8000. An amount of air inducted into the engine 1000 (an output of the engine 1000) is controlled by the electric throttle valve 8016.

Alternatively, instead of the electric throttle valve 8016 or in addition thereto, an air intake valve or an air exhaust valve (both are not illustrated) may be provided. The amount of air inducted into the engine 1000 may be controlled by the lift amount or an opening degree thereof.

The engine speed sensor 8020 detects the rotational speed of the output shaft (crankshaft) of the engine 1000 and transmits a signal that indicates the detected engine speed to the ECU 8000. The input shaft speed sensor 8022 detects the rotational speed of the input shaft NI (turbine speed NT of the torque converter 2100) of the automatic transmission 2000 and transmits a signal that indicates the detected input shaft speed to the ECU 8000. The output shaft speed sensor 8024 detects the rotational speed of the output shaft NO of the automatic transmission 2000 and transmits a signal that indicates the detected output shaft speed to the ECU 8000.

The oil temperature sensor 8026 detects a temperature of oil (ATF: automatic transmission fluid) to be used in an operation or a lubrication of the automatic transmission 2000 and transmits a signal that indicates the detected temperature to the ECU 8000.

The coolant temperature sensor 8028 detects a temperature of coolant in the engine 1000 and transmits a signal that indicates the detected temperature to the ECU 8000.

The ECU 8000 controls various devices to make optimal vehicle traveling state based on a map and a program stored in the ROM 8002 as well as the signals transmitted from the neutral start switch 8006, the accelerator operation amount sensor 8010, the stroke sensor 8014, the throttle opening degree sensor 8018, the engine speed sensor 8020, the input shaft speed sensor 8022, the output shaft speed sensor 8024, the oil temperature sensor 8026, the water temperature and the like.

In the present embodiment, the ECU 8000 controls the automatic transmission 2000 to set one of first to eighth gear steps when the D (drive) range is selected among shift ranges of the automatic transmission 2000 by putting the shift lever 8004 in the D (drive) position. The automatic transmission 2000 transfers driving force to the rear wheels 7000 by setting one of the first to eighth gear steps. Further, in the D range, a high speed gear step exceeding the eight gear steps may be set. The gear step is set based on a speed change line diagram, which has been prepared in advance by using the vehicle speed and the accelerator operation amount as parameters.

As illustrated in FIG. 1, the ECU 8000 includes an engine ECU 8100 that controls the engine 1000; and an ECT (electronically controlled transmission) ECU 8200 that controls the automatic transmission 2000.

The engine ECU 8100 and the ECT_ECU 8200 are configured to transmit/receive signals to/from each other. In the present embodiment, a signal that indicates an operation amount of the accelerator and a target idle speed of the engine 1000 are transmitted from the engine ECU 8100 to the ECT_ECU 8200, and a signal that indicates a required torque determined as a torque output by the engine 1000 is transmitted from the ECT_ECU 8200 to the engine ECU 8100.

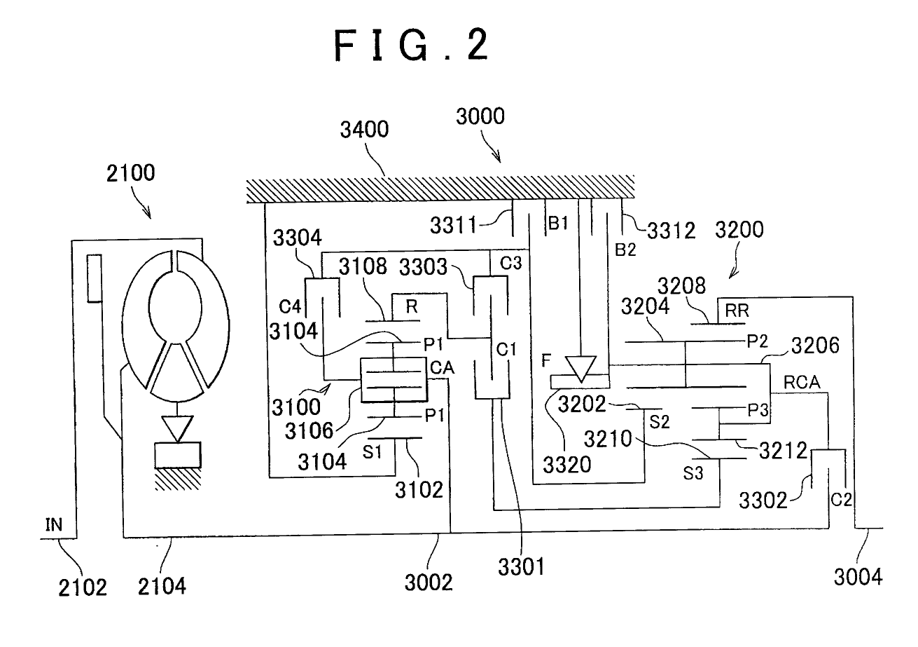

Hereinafter, the planetary gear unit 3000 will be explained with reference to FIG. 2. The planetary gear unit 3000 is connected to the torque converter 2100 having an input shaft 2102 connected to the crankshaft.

The planetary gear unit 3000 includes a front planetary 3100, a rear planetary 3200, a C1 clutch 3301, a C2 clutch 3302, a C3 clutch 3303, a C4 clutch 3304, a B1 brake 3311, a B2 brake 3312 and a one-way clutch (F) 3320.

The front planetary 3100 is a double pinion type planetary gear mechanism. The front planetary 3100 has a first sun gear (S1) 3102, a pair of first pinion gears (P1) 3104, a carrier (CA) 3106 and a ring gear (R) 3108.

The first pinion gears P1 3104 are engaged with the first sun gear S1 3102 and the first ring gear R 3108. The first carrier (CA) 3106 supports the first pinion gears (P1) 3104 to be rotatable and revolvable.

The first sun gear (S1) 3102 is fixed to a gear case 3400 so as not to be rotatable. The first carrier (CA) 3106 is connected to the input shaft 3002 of the planetary gear unit 3000.

The rear planetary 3200 is a Ravigneaux type planetary gear mechanism. The rear planetary 3200 has a second sun gear (S2) 3202, a second pinion gear (P2) 3204, a rear carrier (RCA) 3206, a rear ring gear (RR) 3208, a third sun gear (S3) 3210 and a third pinion gear (P3) 3212.

The second pinion gear P2 3204 is engaged with the second sun gear (S2) 3202, the rear ring gear (RR) 3208 and the third pinion gear (P3) 3212. The third pinion gear (P3) 3212 is engaged with the second pinion gear (P2) 3204 and is also engaged with the third sun gear (S3) 3210.

The rear carrier (RCA) 3206 supports the second pinion gear (P2) 3204 and the third pinion gear (P3) 3212 to be rotatable and revolvable. Further, the rear carrier (RCA) 3206 is connected to the one-way clutch (F) 3320. The rear carrier (RCA) 3206 is not rotatable during the drive of the first gear. The rear ring gear (RR) 3208 is connected to an output shaft 3004 of the planetary gear unit 3000.

The one-way clutch (F) 3320 is provided in parallel with the B2 brake 3312. In other words, the one-way clutch (F) 3320 has an outer race fixed to the gear case 3400 and an inner race connected to the rear carrier (RCA) 3206.

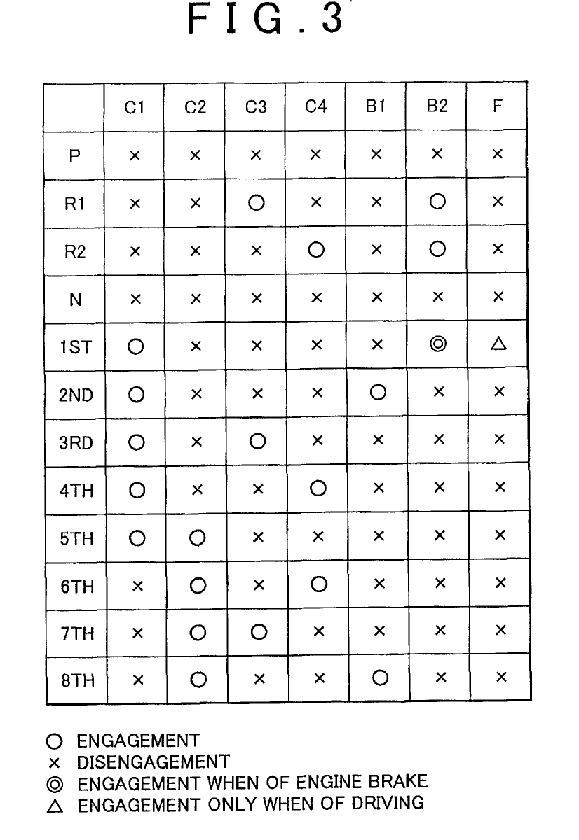

FIG. 3 provides an operation table illustrating a relation ship between the transmission gear ranges and operation states of the clutches and brakes. By operating each of the brakes and the clutches according to the combinations presented in the operation table, first to eighth forward gear steps and first and second reverse gear steps are established.

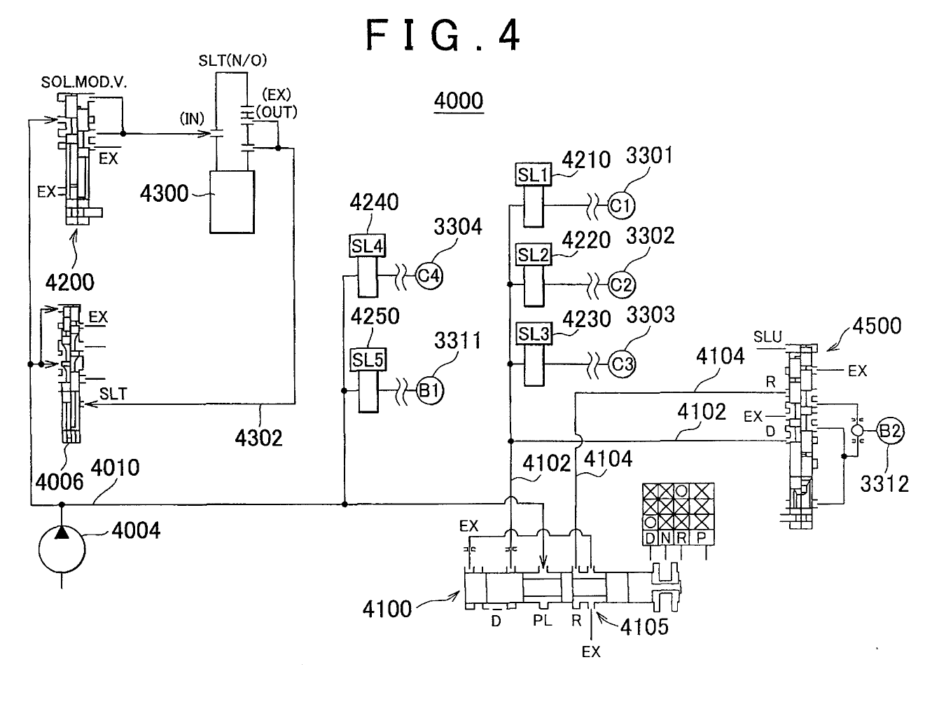

Hereinafter, principal parts of the hydraulic circuit 4000 will be described with reference to FIG. 4. The hydraulic circuit 4000 is not limited to the following.

The hydraulic circuit 4000 includes an oil pump 4004, a primary regulator valve 4006, a manual valve 4100 driven with the shift lever 8004, a solenoid modulator valve 4200, an SL1 linear solenoid (hereinafter, referred to as “SL(1)”) 4210, an SL2 linear solenoid (hereinafter, referred to as “SL(2)”) 4220, an SL3 linear solenoid (hereinafter, referred to as “SL(3)”) 4230, an SL4 linear solenoid (hereinafter, referred to as “SL(4)”) 4240, an SL5 linear solenoid (hereinafter, referred to as “SL(5)”) 4250, an SLT linear solenoid (hereinafter, referred to as “SLT”) 4300 and a B2 control valve 4500.

The oil pump 4004 is connected to the crankshaft in the engine 1000. When the crankshaft rotates, the oil pump 4004 is driven, thereby generating a hydraulic pressure. The hydraulic pressure generated from the oil pump 4004 is regulated by the primary regulator valve 4006. The adjusted pressure becomes a line pressure.

The primary regulator valve 4006 is driven by using as a pilot pressure a throttle pressure regulated by the SLT 4300. The line pressure is supplied to the manual valve 4100 via a line pressure channel 4010.

The manual valve 4100 has a drain port 4105. The hydraulic pressure of a D range pressure channel 4102 and an R range pressure channel 4104 is drained from the drain port 4105. When a spool of the manual valve 4100 is in the D position, the line pressure channel 4010 communicates with the D range pressure channel 4102, so that the hydraulic pressure is supplied to the D range pressure channel 4102. At this time, the R range pressure channel 4104 communicates with the drain port 4105 and, thus, an R range pressure of the R range pressure channel 4104 is drained from the drain port 4105.

When the spool of the manual valve 4100 is in an R position, i.e., when the shift lever 8004 is in an R position, the line pressure channel 4010 communicates with the R range pressure channel 4104, so that the hydraulic pressure is supplied to the R range pressure channel 4104. At this time, the D range pressure channel 4102 communicates with the drain port 4105, so that the D range pressure of the D range pressure channel 4102 is drained from the drain port 4105.

When the spool of the manual valve 4100 is in the N position, i.e., when the shift lever 8004 is in the N position, both of the D range pressure channel 4102 and the R range pressure channel 4104 communicate with the drain port 4105. Accordingly, the D range pressure of the D range pressure channel 4102 and the R range pressure of the R range pressure channel 4104 are discharged from the drain port 4105. As a result, all of the frictional engagement elements (the clutches and the brakes) become disengaged.

The hydraulic pressure supplied to the D range pressure channel 4102 is eventually supplied to the C1 clutch 3301, the C2 clutch 3302 and the C3 clutch 3303. The hydraulic pressure supplied to the R range pressure channel 4014 is eventually supplied to the B2 brake 3312.

The solenoid modulator valve 4200 controls the line pressure at a constant pressure level to generate a hydraulic pressure (solenoid modulator pressure) to be supplied to the SLT 4300.

The SL(1) 4210 regulates the hydraulic pressure to be supplied to the C1 clutch 3301; the SL(2) 4220 regulates the hydraulic pressure to be supplied to the C2 clutch 3302; the SL(3) 4230 regulates the hydraulic pressure to be supplied to the C3 clutch 3303; the SL(4) 4240 regulates the hydraulic pressure to be supplied to the C4 clutch 3304; and the SL(5) 4250 regulates the hydraulic pressure to be supplied to the B1 brake 3311.

In other words, the SL(1) 4210, the SL(2) 4220, the SL(3) 4230, the SL(4) 4240, and the SL(5) 4250 are provided to regulate the hydraulic pressure output from the hydraulic circuit 4000.

The SLT 4300 regulates the solenoid modulator pressure according to the control signals output from the ECU 8000 based on an accelerator operation amount detected by the accelerator operation amount sensor 8010, thereby generating a throttle pressure. The throttle pressure is supplied to the primary regulator valve 4006 via an SLT channel 4302. Further, the throttle pressure is used as the pilot pressure of the primary regulator valve 4006.

The SL(1) 4210, the SL(2) 4220, the SL(3) 4230, the SL(4) 4240, the SL(5) 4250 and the SLT 4300 are controlled by the control signals transmitted from the ECU 8000.

The B2 control valve 4500 selectively supplies to the B2 brake 3312 the hydraulic pressure from one of the D range pressure channel 4102 and the R range pressure channel 4104. The B2 control valve 4500 is connected to the D range pressure channel 4102 and the R range pressure channel 4104. Further, the B2 control valve 4500 is controlled by the hydraulic pressure supplied from the SLU solenoid valve (not illustrated) and also by a bias pressure of a spring.

When the SLU solenoid valve is ON, the B2 control valve 4500 attains a left state shown in FIG. 4 (a drive mode). In this case, the B2 brake 3312 is supplied with the hydraulic pressure having the D range pressure adjusted with the hydraulic pressure that is supplied from the SLU solenoid valve as the pilot pressure.

When the SLU solenoid valve is OFF, the B2 control valve 4500 attains a right state shown in FIG. 4 (a reverse mode). In this case, the B2 brake 3312 is supplied with the R range pressure.

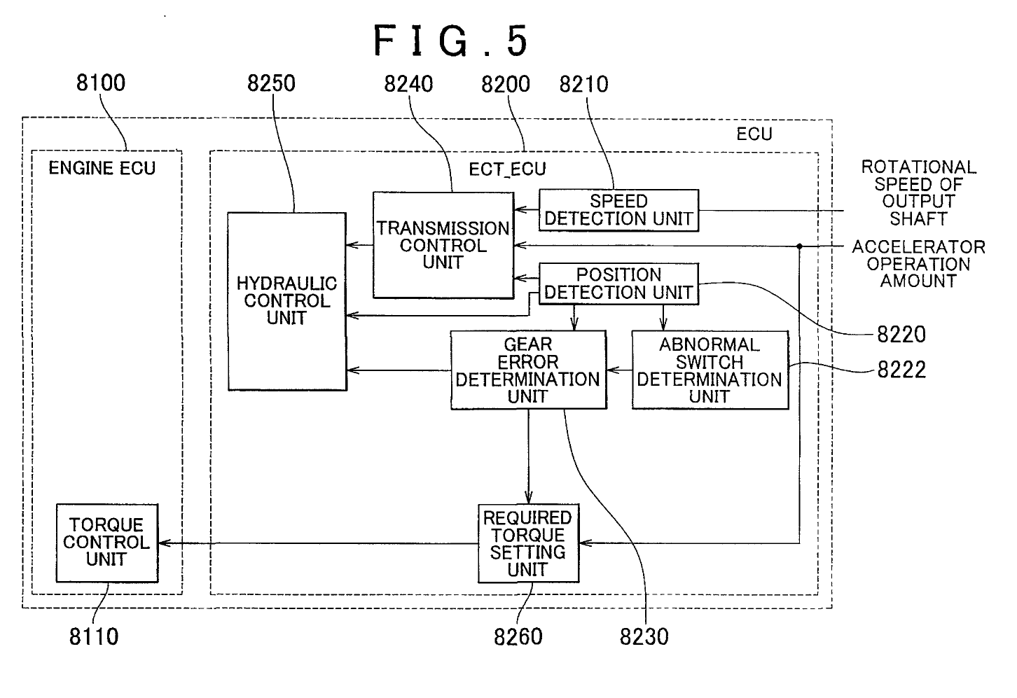

The ECU 8000 will be further described with reference to FIG. 5. The following functions of the ECU 8000 may be implemented either by hardware or by software.

The engine ECU 8100 in the ECU 8000 includes a torque control unit 8110. The torque control unit 8110 receives an amount of torque required from the ECT_ECU 8200. Then, the torque control unit 8110 controls a degree of the throttle opening of the electric throttle valve 8016, ignition timing by an ignition plug and the like so that a torque corresponding to the amount of torque required can be output from the engine 1000.

The ECT_ECU 8200 in the ECU 8000 has a vehicle speed detection unit 8210, a position detection unit 8220, a switch malfunction detecting unit 8222, a gear error determination unit 8230, a transmission control unit 8240, a hydraulic control unit 8250 and a required torque setting unit 8260.

The vehicle speed detection unit 8210 calculates (detects) a vehicle speed based on the rotational speed of the output shaft NO of the automatic transmission 2000.

The position detection unit 8220 detects the position of the shift lever 8004 based on the signal transmitted from the neutral start switch 8006.

The switch malfunction detecting unit 8222 determines whether the neutral start switch 8006 is functioning normally. For example when two or more positions are detected simultaneously or when no position is detected, it is determined that the neutral start switch 8006 is malfunctioning.

If the preset time T(0) has elapsed since the shift lever 8004 was switched from the D position to the N position, the gear error determination unit 8230 determines that a gear step is abnormal (hereinafter, referred to as “gear error”). Herein, the gear error denotes a state that a gear has not been formed as controlled, i.e., a state that the rotational speed of the input shaft N (turbine speed NT) of the automatic transmission 2000 is not synchronous with the rotational speed of the output shaft NO. If the preset time T(0) has elapsed since the shift lever 8004 was switched from the D position to the N position, the hydraulic pressure is discharged from the manual valve 4100, thereby disengaging the frictional engagement elements of the planetary gear unit 3000. At this time, the gear step is not formed. Accordingly, it is considered that the rotational speed of the input shaft NI (turbine speed NT) is not synchronous with the rotational speed of the output shaft NO. For that reason, the gear error is determined when the preset time T(0) has elapsed since the shift lever 8004 had been switched from the D position to the N position.

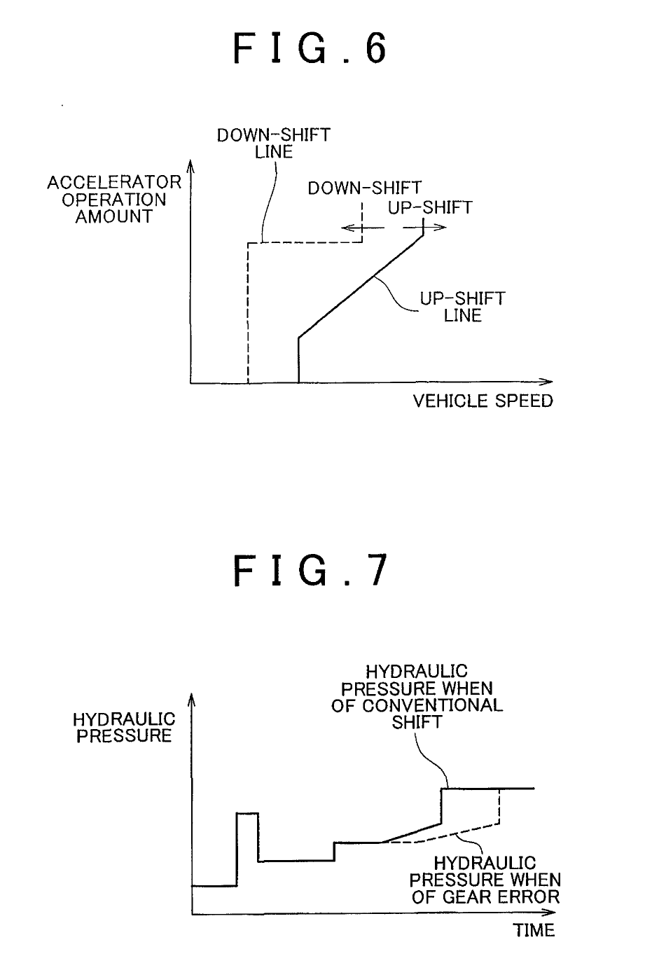

As shown in FIG. 6, the transmission control unit 8240 performs an upshift or a downshift operation according to a speed change line diagram having parameters of a vehicle speed and an accelerator operation amount. In the speed change line diagram, an upshift line and a downshift line are set depending on the type of the gear shifting (combination of gear steps before and after the gear shifting).

The hydraulic control unit 8250 controls the hydraulic pressure that is supplied to the frictional engagement elements of the planetary gear unit 3000.

In this embodiment, the hydraulic control unit 8250 controls the hydraulic pressure in the same manner for both cases where the shift lever 8004 is detected to be in the D position and where the shift lever is detected to be the N position. In other words, a hydraulic control device such as a linear solenoid valve or the like is controlled in the same manner (at the same instruction value) for both cases where the shift lever 8004 is detected to be in the D position and where the shift lever is detected to be in the N position.

If the gear error determination unit 8230 determines that the gear error has occurred when the shift lever 8004 is shifted from the N position to the D position, the hydraulic control unit 8250 controls the hydraulic pressure of the automatic transmission 2000 so that the frictional engagement elements may be engaged loosely in comparison with conventional gear shifting.

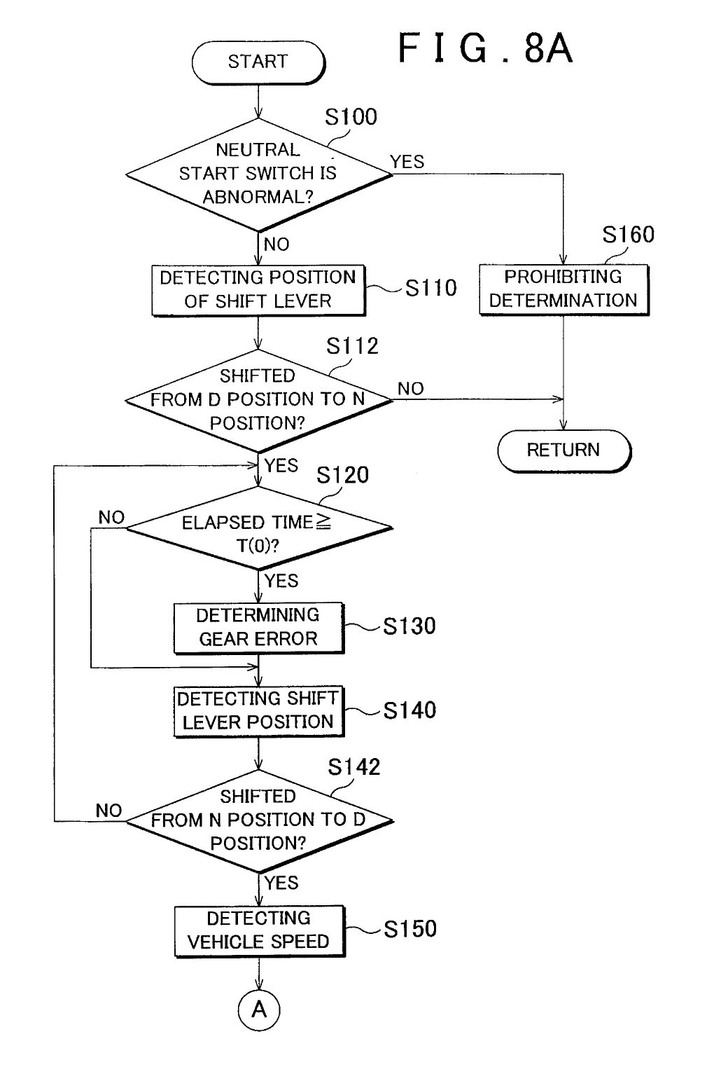

To be specific, when the gear error determination unit 8230 determines that the gear error has occurred, as shown in FIG. 7, the hydraulic control unit 8250 executes a control so that the hydraulic pressure to be supplied to engage the frictional engagement elements is gradually increased in comparison with conventional gear shifting. However, the method that allows the loose engagement of the frictional engagement elements is not limited to the above.

The required torque setting unit 8260 sets the amount of torque required by the engine 1000 based on the accelerator operation amount and the like.

In this embodiment, if the gear error determination unit 8230 determines that the gear error has occurred when the shift lever 8004 has been shifted from the N position to the D position, the required torque setting unit 8260 sets the amount of torque to be less than or equal to a preset torque TO(0).

After the throttle opening degree of the electric throttle valve 8016, the ignition timing by the ignition plug and the like are controlled by the torque control unit 8110 of the engine ECU 8100 based on the required torque less than or equal to the torque TO(0), if it is determined that the gear error has occurred, the output torque of the engine 1000 becomes less than or equal to the torque TO(0).

When the shift lever 8004 is switched from the N position to the D when it has been determined that the gear error has occurred, the hydraulic pressure of the automatic transmission 2000 is controlled so that the frictional engagement elements may be engaged loosely in comparison with conventional gear shifting. Further, the output torque of the engine 1000 is controlled to be less than or equal to the torque TO(0). The above-described control will be referred to as “ND control” hereinafter.

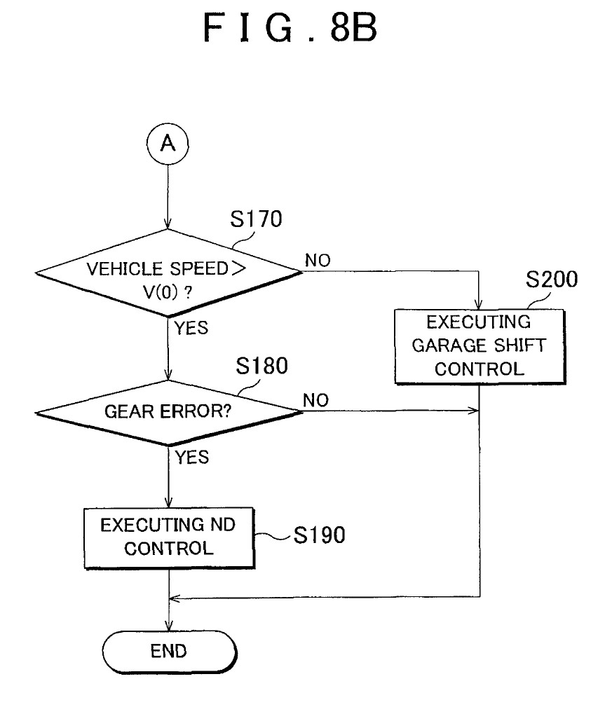

Hereinafter, a control sequence of a program executed by the ECU 8000 will be described with reference to FIGS. 8A and 8B. Further, the program described below is at predetermined intervals.

In step (hereinafter, referred to as “S”) 100, the ECU 8000 determines whether the neutral start switch 8006 is functionally normally based on the signal transmitted from the neutral start switch 8006. If the ECU 8000 determines that the neutral start switch 8006 is malfunctioning (YES in step S100), the process proceeds to step S160. Otherwise (NO in step S100), the process proceeds to step S110.

In step S110, the ECU 8000 detects a position of the shift lever 8004 based on the signal transmitted from the neutral start switch 8006.

In step S112, the ECU 8000 checks whether the shift lever 8004 has been shifted from the D position to the N position. If the ECU 8000 determines that the shift lever 8004 has been shifted from the D position to the N position (YES in step S112), the process proceeds to step S120. If not (NO in step S112), the process ends.

In step S120, the ECU 8000 checks whether the time that has elapsed since the shift lever 8004 had been shifted from the D position to the N position exceeds preset time T(0). If the ECU 8000 determines that the time which has elapsed since the shift lever 8004 had been shifted from the D position to the N position exceeds the preset time T(0) (YES in step S120), the process proceeds to step S130. Otherwise (NO in step S120), the process proceeds to step S140. In step S130, the ECU 8000 determines that the gear error has occurred.

In step S140, the ECU 8000 detects the position of the shift lever 8004 based on the signal transmitted from the neutral start switch 8006.

In step S142, the ECU 8000 checks whether the shift lever 8004 has been shifted from the N position to the D position. If the ECU 8000 determines that the shift lever 8004 has been shifted from the N position to the D position (YES in step S142), the process proceeds to step S150. Otherwise (NO in step S142), the process returns to step S120.

In step S150, the ECU 8000 detects the vehicle speed based on the signal transmitted from the output shaft speed sensor 8024.

In step S160, the ECU 8000 is prohibited from determining whether the time that has elapsed since the shift lever 8004 had been shifted from the D position to the N position exceeds the preset time T(0) and from determining that the gear error has occurred.

In step S170, the ECU 8000 determines whether the vehicle speed is greater than a threshold value V(0). If the ECU 8000 determines that the vehicle speed is greater than the threshold value V(O) (YES in step S170), the process proceeds to step S180. If not (NO in step S170), the process proceeds to step S200.

In step S180, the ECU 8000 determines whether the gear error has occurred. If the ECU 8000 that the gear error has occurred (YES in step S180), the process proceeds to step S190. Otherwise (NO in step S180), the process ends.

In step S190, the ECU 8000 executes the ND control. Specifically, the hydraulic pressure of the automatic transmission 2000 is controlled so that the frictional engagement elements can be engaged loosely compared with the conventional gear shifting and, also, the output torque of the engine 1000 is reduced to be less than or equal to the torque TO(0).

In step S200, the ECU 8000 executes a garage shift control in which the frictional engagement elements are engaged loosely. Because the garage shift control may be executed by using a generally known technique, a detailed description thereof will be omitted.

The following is a description of an operation of the ECU 8000 as the control device in accordance with the present embodiment.

If the neutral start switch 8006 is not malfunctioning while the vehicle is being driven (NO in step S100), i.e., if the neutral start switch 8006 is operating normally, the position of the shift lever 8004 is detected based on the signal transmitted from the neutral start switch 8006 (step S110).

When the shift lever 8004 is shifted from the D position to the N position (YES in step S112), it is checked whether the time that has elapsed since the shift lever 8004 was shifted from the D position to the N position exceeds the preset time T(0) (step S120).

Right after the shift lever 8004 is shifted from the D position to the N position, the time that has elapsed since the shift lever 8004 had been shifted from the D position to the N position is shorter than the preset time T(0) (NO in step S120).

In that case, the position of the shift lever 8004 is detected (step S140) and, then, it is determined whether the shift lever 8004 was shifted from the N position to the D position (step S142).

When the shift lever 8004 is maintained in the N position without being switched from the N position to the D position (NO in step S142) and, also, the elapsed time exceeds the preset time T(0) (YES in step S120), the frictional engagement elements would have been disengaged by discharging the hydraulic pressure from the manual valve 4100. In other words, the gear step has not been formed in the automatic transmission 2000. In this case, it is determined that the gear error has occurred (step S130).

Next, when the shift lever 8004 is switched from the N position to the D position (YES in step S142), the vehicle speed is detected (step S1150).

If the vehicle speed is greater than the threshold value V(0) (YES in step S170) and the gear error has occurred (YES in step S180), then the ND control is executed (step S190). Accordingly, the disengaged frictional engagement elements may be engaged loosely and, hence, it is possible to reduce a shock generated when the frictional engagement elements are engaged.

Meanwhile, if the shift lever 8004 is rapidly switched from the D position to the N position and then to the D position, it is considered that the shift lever 8004 has been switched to the D position before the frictional engagement elements are disengaged.

Therefore, if the shift lever 8004 is switched from the N position to the D position (YES in step S1142) before the time that has elapsed since the shift lever 8004 had been switched from the D position to the N position exceeds the preset time T(0), it is determined that the gear error has not occurred.

At this time, if the vehicle speed is greater than the threshold value V(0) (YES in step S170), the ND control is not executed because it is determined that the gear error has not occurred (NO in step S180). Because the frictional engagement elements are engaged, there is a low possibility of a shock generation, thereby restraining the ND control. As a result, an unnecessary control may be avoided.

On the other hand, if the vehicle speed is less than or equal to the threshold value V(0) (NO in step S170), the garage shift control is executed regardless of whether the gear error has occurred.

However, because the occurrence of the gear error is determined based on the position of the shift lever 8004, the occurrence of the gear error cannot be accurately determined when the neutral start switch 8006 is malfunctioning.

Therefore, if the neutral start switch 8006 is malfunctioning (YES in step S100), the control sequence is prohibited from determining whether the time that has elapsed since the shift lever 8004 was switched from the D position to the N position exceeds the preset time T(0). The control sequence then determines whether the gear error has occurred (step S160). Accordingly, it is possible to prevent a mistaken decision in determining whether the gear error has occurred.

While the invention has been shown and described with respect to the example embodiments, it will be understood by those skilled in the art that various changes and modification may be made without departing from the scope of the invention as defined in the following claims.

What is claimed is:

1. A control device for a vehicle equipped with an automatic transmission that forms gear steps by engaging frictional engagement elements, comprising:
a detection unit that detects a position of a transmission selection member manipulated by a driver;
a determination unit that determines whether a gear step is abnormal when a preset time has elapsed after the transmission selection member is shifted from a drive position to a neutral position; and
a control unit that controls the automatic transmission such that if the transmission selection member is shifted from the neutral position to the drive position when the gear step has been determined to be abnormal, a shock generated by the engagement of the frictional engagement elements is reduced.

2. The control device according to claim 1, wherein the control unit controls the automatic transmission such that if the transmission selection member is shifted from the neutral position to the drive position when the gear step has been determined to be abnormal, the frictional engagement elements are engaged loosely in comparison to when the transmission selection member is maintained in the drive position and the frictional engagement elements are engaged normally.

3. The control device according to claim 1, wherein the frictional engagement elements are engaged by a hydraulic pressure supplied thereto, and
wherein the control unit includes a unit that controls the automatic transmission such that if the transmission selection member is switched from the neutral position to the drive position when the gear step is determined to be abnormal, a hydraulic pressure supplied to the frictional engagement elements is slowly increased in comparison to when the transmission selection member is maintained in the drive position and the frictional engagement elements are engaged normally.

4. The control device according to claim 1, further comprising:
a unit that controls a power source connected to the automatic transmission such that if the transmission selection member is switched from the neutral position to the drive position when the gear step is determined to be abnormal, an output torque from the power source is reduced to or below a predetermined value.

5. The control device according to claim 1, further comprising:
an error determination unit that determines whether the detection unit is functioning normally; and
a unit that prohibits the determination unit from determining whether or not the gear step is abnormal if the error determination unit determines that the detection unit is malfunctioning.

6. The control device according to claim 5, wherein when two or more positions are detected simultaneously or when no position is detected, the error determination unit determines that the detection unit is malfunctioning.

7. The control device according to claim 1, wherein the determination unit determines a gear step is abnormal when a rotational speed of an input shaft of the automatic transmission is not synchronous with a rotational speed of an output shaft of the automatic transmission.

8. The control device according to claim 1, wherein the control unit controls the automatic transmission such that if the transmission selection member is shifted from the neutral position to the drive position when the gear step has been determined to be abnormal and a vehicle speed is greater than a predetermined threshold value, a shock generated by the engagement of the frictional engagement elements is reduced.

9. A control device for a vehicle equipped with an automatic transmission that forms gear steps by engaging frictional engagement elements, comprising:
detection means for detecting a position of a transmission selection member manipulated by a driver;
determination means for determining whether a gear step is abnormal when a preset time has elapsed after the transmission selection member is shifted from a drive position to a neutral position; and
control means for controlling the automatic transmission such that if the transmission selection member is shifted from the neutral position to the drive position when the gear step has been determined to be abnormal, a shock generated by the engagement of the frictional engagement elements is reduced.

10. A control method for a vehicle equipped with an automatic transmission that forms gear steps by engaging frictional engagement elements, comprising:
detecting a position of a transmission selection member;
determining whether a gear step is abnormal when a preset time has elapsed after the transmission selection member is shifted from a drive position to a neutral position; and
controlling the automatic transmission such that if the transmission selection member is shifted from the neutral position to the drive position when the gear step has been determined to be abnormal, a shock generated by the engagement of the frictional engagement elements is reduced.

11. The control method according to claim 10, wherein the automatic transmission is controlled such that if the transmission selection member is shifted from the neutral position to the drive position when the gear step has been determined to be abnormal, the frictional engagement elements are engaged loosely in comparison to when the transmission selection member is maintained in the drive position and the frictional engagement elements are engaged normally.

12. The control method according to claim 10, wherein the frictional engagement elements are engaged by a hydraulic pressure supplied thereto, and
wherein the automatic transmission is controlled such that if the transmission selection member is switched from the neutral position to the drive position when the gear step is determined to be abnormal, a hydraulic pressure supplied to the frictional engagement elements is slowly increased in comparison to when the transmission selection member is maintained in the drive position and the frictional engagement elements are engaged normally.

13. The control method according to claim 10 further comprising:
controlling a power source connected to the automatic transmission such that if the transmission selection member is switched from the neutral position to the drive position when the gear step is determined to be abnormal, an output torque from the power source is reduced to or below a predetermined value.

14. The control method according to claim 10, further comprising:
determining whether the detection of the position of the transmission selection member is malfunctioning; and
prohibiting the determination whether or not the gear step is abnormal if it is determined that the detection of the position of the transmission selection member is malfunctioning.

15. The control method according to claim 14, wherein when two or more positions are detected simultaneously or when no position is detected, it is determined that the detection of the position of the transmission selection member is malfunctioning.

16. The control method according to claim 10, wherein it is determined that a gear step is abnormal when a rotational speed of an input shaft of the automatic transmission is not synchronous with a rotational speed of an output shaft of the automatic transmission.

17. The control method according to claim 10, wherein the automatic transmission is controlled such that if the transmission selection member is shifted from the neutral position to the drive position when the gear step has been determined to be abnormal and a vehicle speed is greater than a predetermined threshold value, a shock generated by the engagement of the frictional engagement elements is reduced.
